(19) United States
(12) Patent Application Publication
(10) Pub. No.: US 2012/0139302 A1
(43) Pub. Date: Jun. 7, 2012

(54) AIRPLANE PASSENGER SEAT

(75) Inventors: Jean-Claude Andre Estevenin, Seattle, WA (US); Perry G. Estevenin, Seattle, WA (US)

(73) Assignee: Jcedesign, Seattle, WA (US)

(21) Appl. No.: 13/306,851

(22) Filed: Nov. 29, 2011

Related U.S. Application Data
(60) Provisional application No. 61/419,531, filed on Dec. 3, 2010.

(51) Int. Cl. B64D 11/06

(52) U.S. Cl. 297/162; 297/326

(57) ABSTRACT

An airplane passenger seat may include a non-articulated seat shell configured to recline as a unit. In embodiments, an airplane passenger seat may include a tray table including a literature pocket.

### BACKGROUND

In commercial aviation, passenger comfort can be a deciding factor in choices made by the flying public. Passenger seat design is constrained by safety requirements and weight limitations. These constraints have limited innovative new passenger seat designs, especially in economy class seating.

According to the prior art, airplane passenger seats, and especially economy class airplane passenger seats provide limited comfort. Seats are typically formed as a separate seat cushion and back cushion that articulate relative to one another. A seat cushion remains in a stationary, substantially horizontal plane relative to the passenger cabin floor. A back cushion typically is allowed to recline by some limited amount. While the reclining back cushion provides a degree of comfort to the passenger, they are often not as comfortable as passengers would like.

According to the prior art, airplane passenger seats may include literature pockets that interfere with passenger knee room.

What is needed is an airplane passenger seat design that improves passenger comfort compared to previous seats, while also being relatively low weight. Such a seat design must also meet difficult regulations for maintaining seat integrity during high acceleration loads presented by an emergency landing or crash, in order to prevent avoidable loss of life stemming from seats collapsing or becoming disengaged from the floor of the passenger cabin.

### SUMMARY

According to embodiments, an airplane passenger seat includes a non-articulating seat shell. The non-articulating seat shell may be pivotably coupled to a seat support configured to mount to a floor of an airplane fuselage with a pivot configured to allow rotation of the seat shell relative a rear support beam. According to another embodiment, the pivot may be configured to allow rotation of the seat shell relative a forward support beam. The assembly is configured to withstand 16 G acceleration without detaching from the floor or collapsing on itself.

According to another embodiment, an airplane passenger seat may include a tray table operatively coupled to a literature pocket. Coupling the literature pocket to the tray table and/or forming the literature pocket integrally with the tray table may remove bulk from the passenger knee area and thereby increase passenger comfort. The tray table with coupled or integral literature pocket may be used with an airplane seat having a seat shell with non-articulating back or with a conventional articulating back airplane seat.

### BRIEF DESCRIPTION OF THE DRAWINGS

FIG. 1 is a view of an airplane passenger seat including a non-articulating seat shell, according to an embodiment

FIG. 2 is a view of the airplane passenger seat of FIG. 1 showing the location of forward and rear support beams and two recline positions, according to an embodiment.

FIG. 3 is a view of the airplane passenger seat of FIGS. 1 and 2, according to an embodiment.

FIG. 4 is a view of the underside of the airplane passenger seat of FIGS. 1-3, showing an arrangement of seat recline springs, according to an embodiment.

FIG. 5 is a detail view showing a spring arrangement shown in FIG. 4, according to an embodiment.

FIG. 6 is a view of an airplane passenger seat including a non-articulating seat shell, according to another embodiment.

FIG. 7 is a view of the airplane passenger seat of FIG. 6 showing two recline positions, according to an embodiment.

FIG. 8 is a view of the underside of the airplane passenger seat of FIGS. 6-7, showing an arrangement of seat recline springs, according to an embodiment.

FIG. 9 is a view of an airplane passenger seat showing a tray table arrangement, according to an embodiment.

FIG. 10 is a view of a portion of an airplane passenger seat showing a tray table arrangement, according to another embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

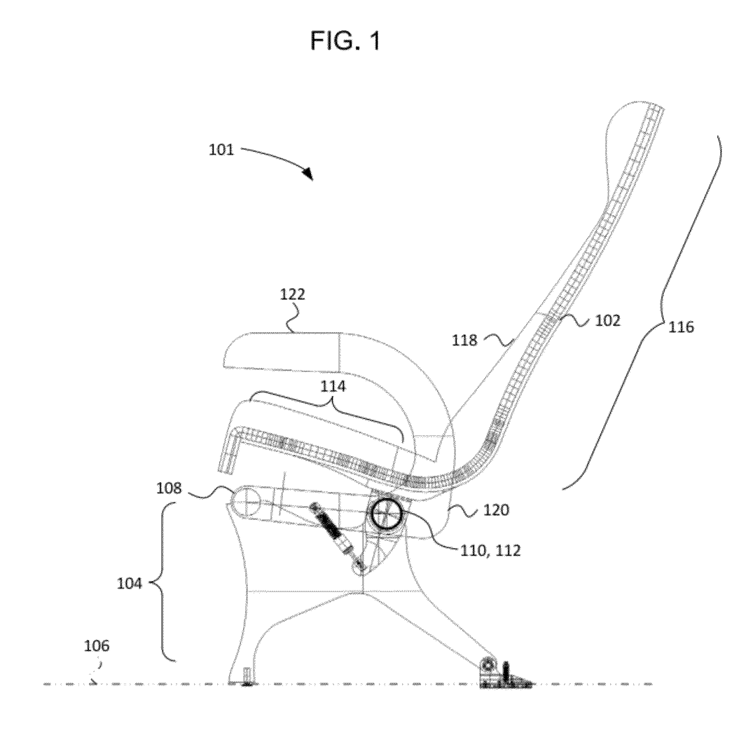

FIG. 1 is a view of an airplane passenger seat 101 including a non-articulating seat shell 102 and a seat support 104 configured to mount to a floor of an airplane fuselage 106, according to an embodiment. A forward support beam 108 and a rear support beam 110 are mounted on the seat support 104. According to typical Federal Aviation Administration (FAA) regulations, the seat support 104 and the support beams 108, 110 are configured to hold the seat and a person in the seat while withstanding sixteen times the force of gravitational acceleration (16 G acceleration) without detaching from the floor 106 or collapsing.

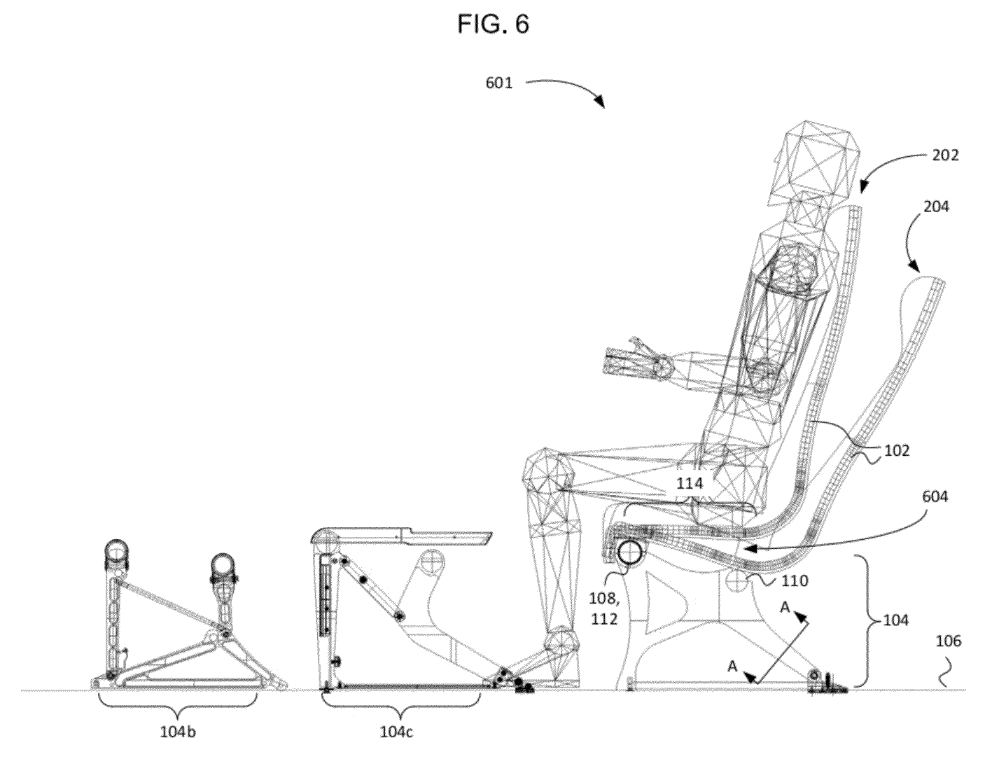

A pivot 112 may be operatively coupled to the seat shell 102 and one of the support beams 108, 110. The pivot 112 may be configured to allow rotation of the seat shell 102 relative to the forward and rear support beams 108, 110. The rotation offered by the pivot provides for at least one upright position and at least one reclining position of the non-articulated seat shell 102 relative to the floor 106. FIGS. 1-5 illustrate an airplane passenger seat embodiment 101 configured with a pivot 112 that provides rotation around the rear support beam 110. FIGS. 6-8 illustrate an airplane passenger seat embodiment 601, 701 configured with a pivot 112 that provides rotation around the forward support beam 108.

The non-articulated seat shell 102 may include a seat pan 114 disposed in a substantially horizontal plane and an integrally formed backrest support 116 rising in a generally upward and rearward slope from the seat pan 114. The seat shell 102 may be formed from a number of conventional processes such as sheet metal (e.g. aluminum) stamping, glass fiber reinforced epoxy (fiberglass), carbon fiber reinforced epoxy, glass-filled injection molded plastic, etc. The seat shell 102 may be formed according to a compound curvature selected to generally conform to the body shape of an average or other airplane passenger.

At least one cushion 118 may be disposed superjacent the non-articulated seat shell 102, as shown. For example, the cushion 118 may be formed as separate seat pan and backrest cushions. Alternatively, the cushion 118 may be a single cushion mounted over a seat pan portion 114 and a backrest support portion 116 of the non-articulated seat shell 102. The cushion 118 may be formed from a closed cell foam or open cell foam material. Optionally, the cushion(s) 118 may be molded or otherwise formed to fit tightly against a seat shell 102 that is formed according to the compound curvature described above.

A seat cross 120 may be mechanically coupled to the forward support beam 108 and the rear support beam 110. The seat cross may mechanically couple the rear support beam 110 to the forward support beam 108 to distribute any acceleration load from the pivot over both seat support beams 108, 110. The seat cross 120 may include an armrest 122, as shown. Typically, the seat cross 120 may also provide an anchor point for passenger seat belts (not shown), and may support one or more spring anchors (described below).

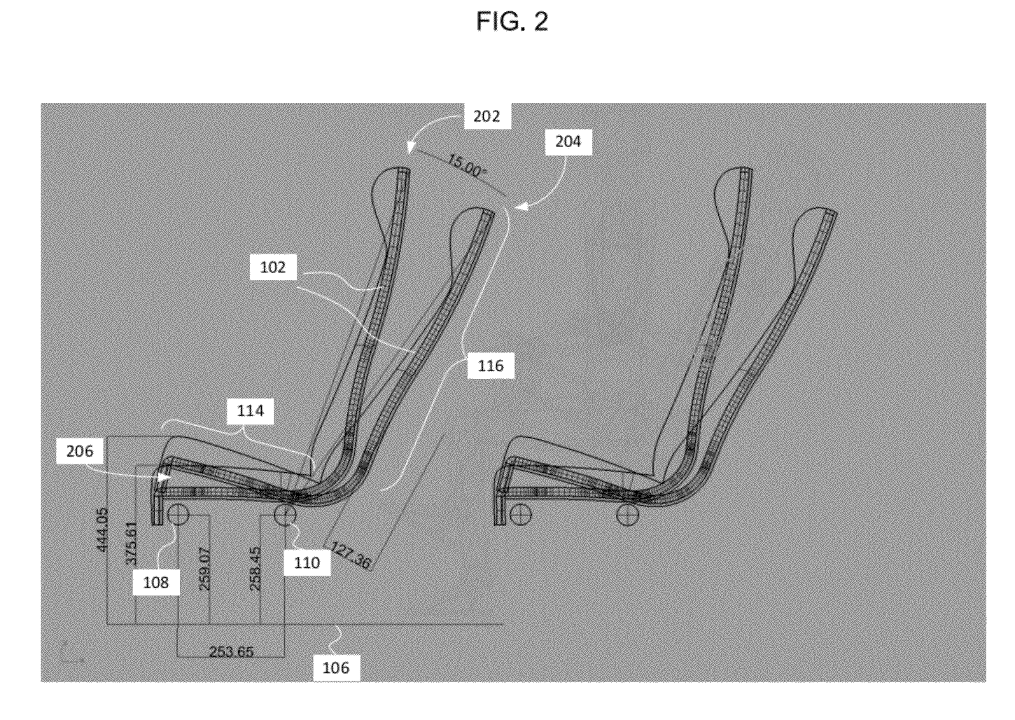

FIG. 2 is a view of the airplane passenger seat 101 of FIG. 1 showing the location of forward and rear support beams 108, 110 and two recline positions 202, 204, according to an embodiment. The seat support 104 is omitted for clarity. Because the seat shell 102 is not articulated, the seat pan 114 rotates with the backrest support 116 during recline. In an upright position 202, the seat pan 114 may be in contact with or nearly in contact with both the forward and rear support beams 108, 110. In a reclined position 204, the forward edge of the seat pan 114 may rise above the forward support beam 108 to create a gap 206. According to an embodiment, the non-articulating seat shell 102 may be configured to recline up to about 15 degrees from nominal.

As described above, the seat support 104, and the forward and rear support beams 108, 110 are specified to withstand a 16 G acceleration without detaching from the floor or collapsing. To meet this standard, the seat 101 may be configured to work with forward and rear support beams 108, 110 that are supported a distance from the floor 116 no greater than the distance of forward and rear support beams for an airplane seat with an articulating seat and back. That is, the seat 101 may be configured to include or work with standard forward and rear support beams 108, 110. Alternatively, the seat 101 may include non-standard forward and rear support beams 108, 110. For example, the forward and/or rear support beams 108, 110 may be supported at a distance from the floor 116 less than the corresponding distance(s) of support beams configured to work with an articulating seat and back. As may be seen in FIG. 2, the forward and rear support beams 108, 110 can be supported at a distance of less than about 300 millimeters from the floor 116 to the beam axes. According to an embodiment, the forward and rear support beams 108, 110 may be supported at a distance equal to or less than about 260 millimeters from the floor 116 to each beam axis.

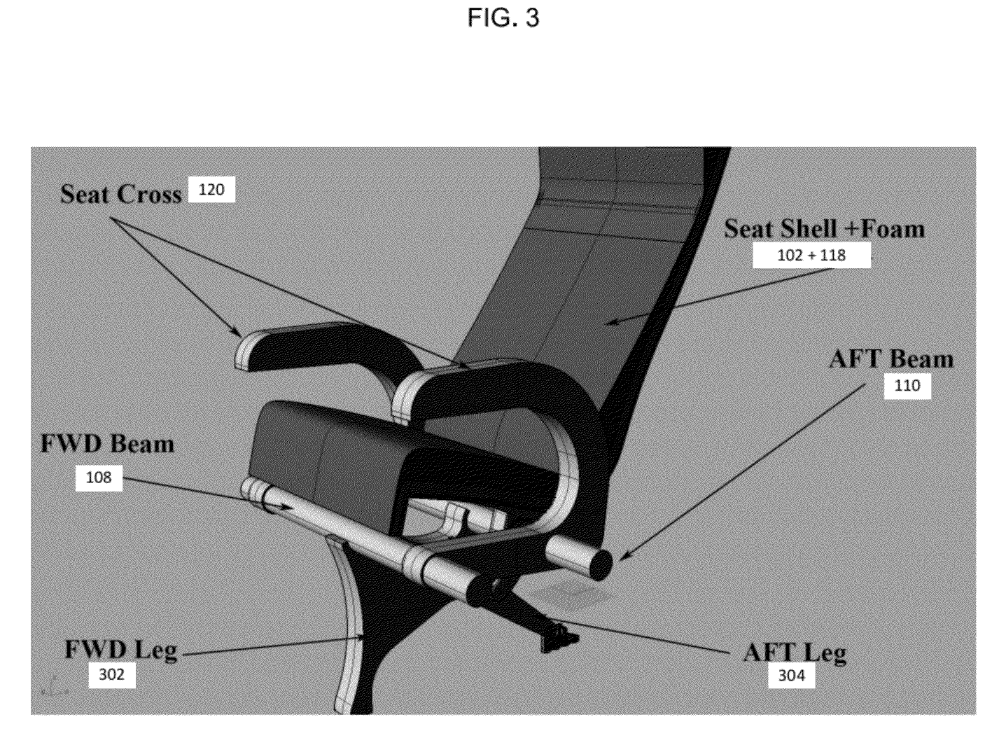

FIG. 3 is a perspective view of the airplane passenger seat of FIGS. 1 and 2, according to an embodiment. To distribute acceleration loads, the seat cross 120 may be configured to mechanically couple the forward support beam 108 to the rear support beam 110 and distribute an acceleration load from the pivot (not shown). The forward and rear support beams 108, 110 are supported by a forward leg 302 and an aft leg 304 that are included as portions of the seat support 104. The bottoms of the forward and aft legs 302, 304 are mechanically coupled to the floor 116 of the airplane.

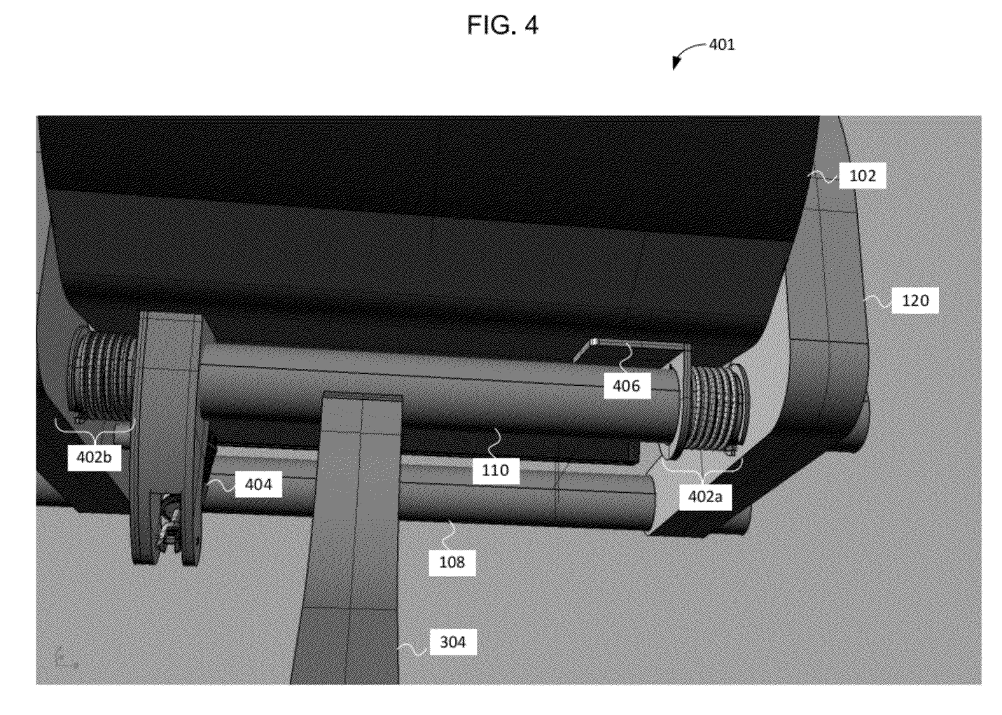

FIG. 4 is a view of the underside of the airplane passenger seat of FIGS. 1-3, showing an arrangement of seat recline springs 402a, 402b, 404, according to an embodiment. The seat recline springs include at least one spring configured to urge the non-articulated seat shell 102 into an upright position, for example when a person releases a recline control. At least one torsion spring, shown as two torsion springs, 402a, 402b, may act to rotate the seat shell 102 around the rear support beam 110. A mounting point 406 may couple the torsion spring 402a to the seat shell 102. The other end of the torsion spring 402a may be anchored to the seat cross 120, which may also couple the rear support beam 110 to the forward support beam 108. The rear leg 304 subtends the front leg in FIG. 4, hiding the front leg from view.

Optionally, a spring 404 may operate to damp rotation of the seat shell 102 and/or provide forward pressure on the seat shell 102. Optionally, the spring arrangement 401 may include the spring 404 as a second or third spring configured to cooperate with one or more torsion springs 402a, 402b.

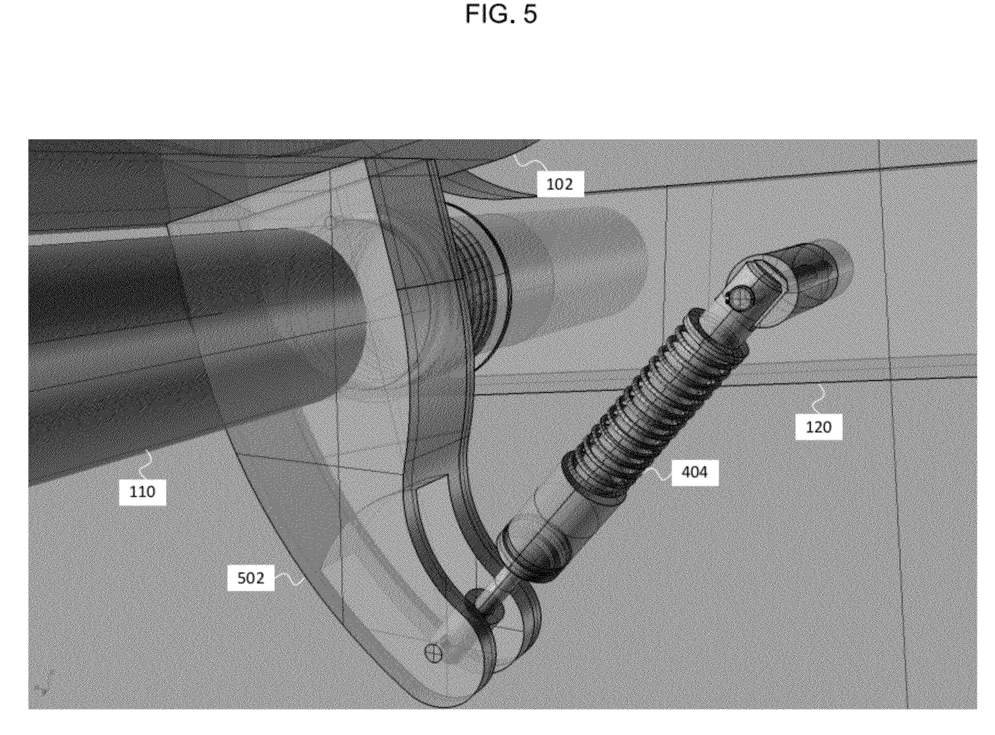

FIG. 5 is a detail view showing a compression spring 404 configured to act on a bell crank 502 located to transfer forward pressure seat shell 102 in rotation around the rear support beam 110. A fixed end of the compression spring 404 may be anchored to the seat cross 120. Optionally, the compression spring 404 may include a gas spring and/or a gas damper.

During an acceleration load (up to 16 G), the seat shell 102 may rotate forward with the forward edge of the seat pan 114 coming to rest substantially upon the forward support beam 108. The seat cross 120 may mechanically couple the forward and rear support beams 108, 110, and allow the seat 101 to resist acceleration in a way similar to a conventional articulated airplane passenger seat.

FIG. 6 is a view of an airplane passenger seat 601 including a non-articulating seat shell 102, according to another embodiment where the seat shell 102 is configured to rotate around the forward support beam 108. A pivot 112 is operatively coupled to the forward support beam. The rear of the non-articulating seat shell 102 may be configured to sink below the level of the forward support beam 108 when the seat is in a reclined position 204. To make room for this, the rear support beam 110 may be supported by the seat support 104 at a lower height above the floor than the forward support beam 108, and at a lower height than a standard height of a rear support beam used with an articulated seat. When the seat 601 is in an upright position 202, the rear portion of the seat pan is raised to a level above the rear beam.

Two alternative seat support assemblies are shown as 104b and 104c.

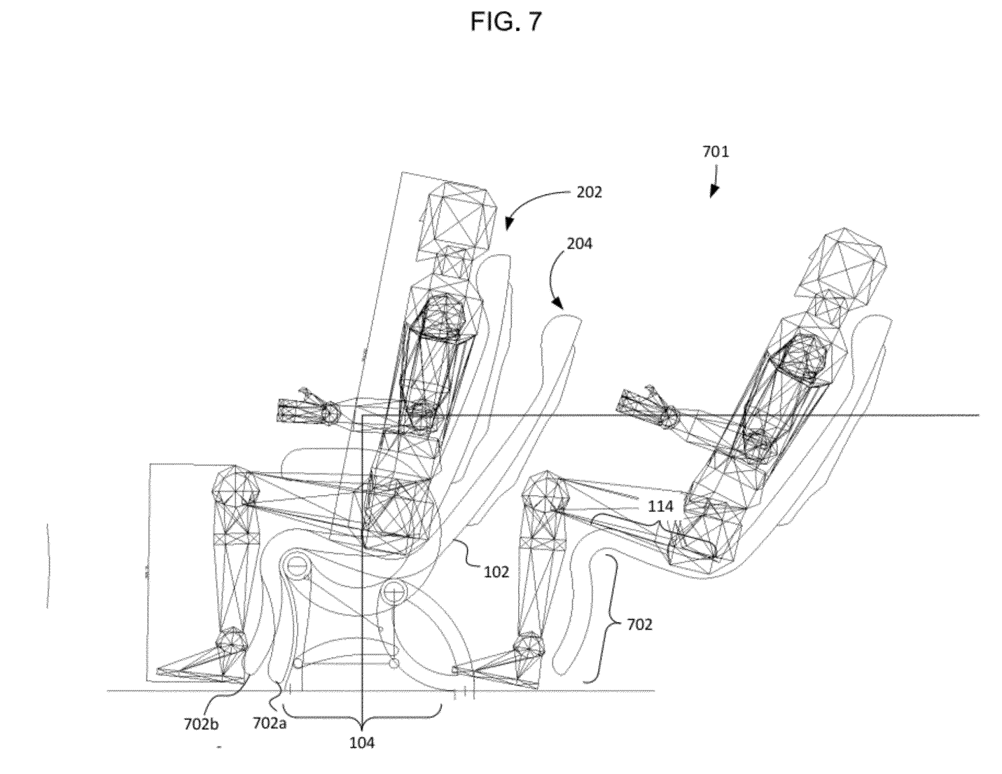

FIG. 7 is a view of a variant 701 of airplane passenger seat 601 of FIG. 6, according to an embodiment. The seat 701 is shown in two recline positions 202, 204. The seat 701 may include a leg rest 702 projecting generally downward from a forward edge of the seat pan 114. When the seat 701 is in the upright position 202, the leg rest 702 may be held in a retracted position 702a near the front edge of the seat support 104. When the seat 701 is in a reclined position 204, the leg rest 702 may project to a forward position 702b. The leg rest 702 may be formed integrally with the seat pan 114 and the seat shell 102. Optionally, the leg rest 702 may be articulated to project farther forward than position 702b in the reclined 204 position of the seat 701.

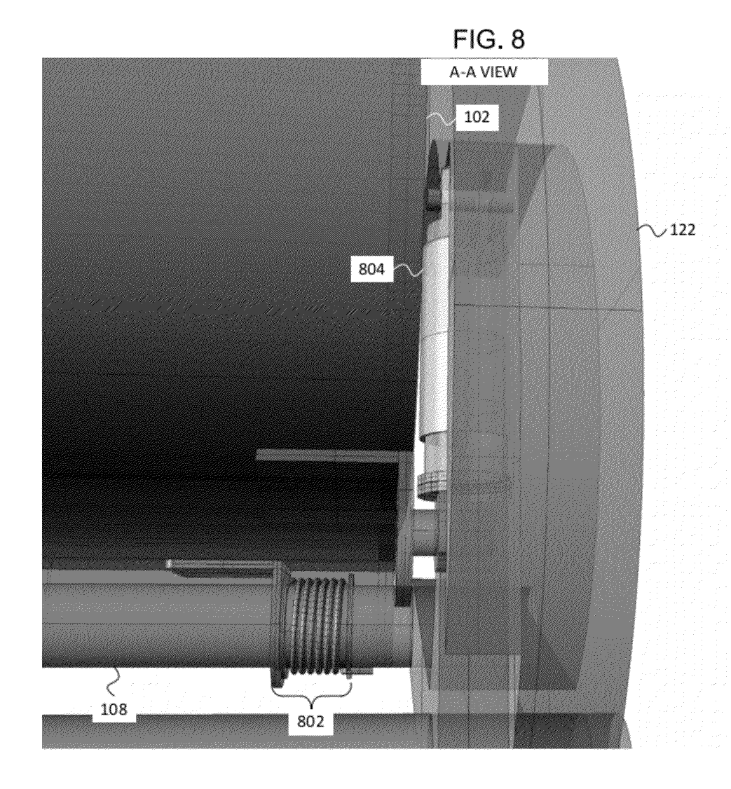

FIG. 8 is a view of the seat from approximately the direction A-A shown in FIG. 6. The A-A view shows the underside of the airplane passenger seat 601, 701 of FIGS. 6-7, showing an arrangement of seat recline springs 802, 804, according to an embodiment. The springs 802, 804 (which may be a single spring in some embodiments) are configured to urge the non-articulated seat shell into an upright position when a person releases a recline control. A torsion spring 802 may be formed peripherally to the forward support beam 108, and may provide a force to rotate the seat shell 102 and the seat pan 114 into a position that is raised relative to the rear support beam, shown as the gap 604 in FIG. 6. Optionally, a tension spring 804 may be configured to pull upward on the rear of the seat shell 102 and seat pan 114 from the seat cross 122. The tension spring may include a gas spring or gas damper. Alternatively, a compression spring 804 may be configured to push upward on the rear of the seat shell 102 and seat pan 114 from the seat cross 122, the rear beam 110, and/or the seat support 104. The compression spring may include a gas spring or gas damper. Similarly to the embodiment of FIGS. 1-5, the embodiment of FIGS. 6-8 may allow the non-articulating seat shell 102 to recline up to about 15 degrees from nominal, illustrated as position 204.

Referring to FIGS. 6-8, a seat cross 122 may be configured to mechanically couple the forward support beam 108 to the rear support beam 110 and distribute an acceleration load from the pivot. During an acceleration load (up to 16 G), the seat shell 102 corresponding to the seat embodiment 601, 701 of FIGS. 6-8 may rotate forward with the rear edge of the seat pan 114 coming to rest below a hard stop supported by the seat cross 120 and/or the rear support beam 110. The seat cross 120 may mechanically couple the forward and rear support beams 108, 110, and allow the seat 101 to resist acceleration in a way similar to a conventional articulated airplane passenger seat.

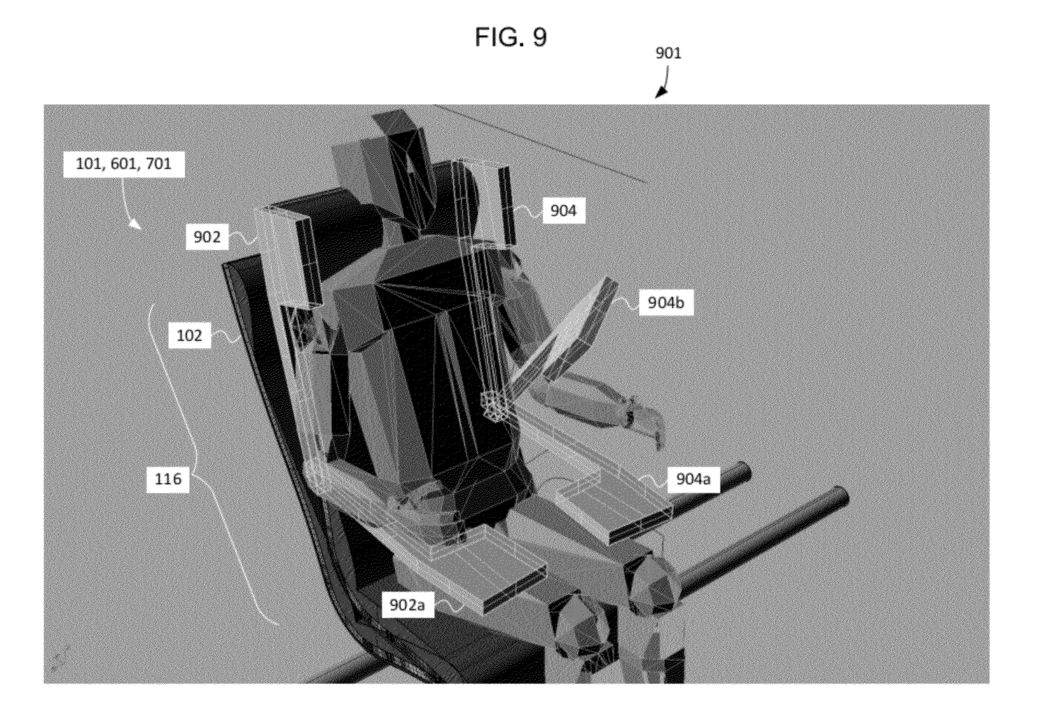

FIG. 9 is a view of an airplane passenger seat showing a tray table arrangement 901, according to an embodiment. Optionally, the tray table arrangement 901 may be deployed from an armrest 122 included in the seat cross 120. In the embodiment depicted in FIG. 9, the tray table(s) may be configured to pivot from the backrest support 116 or the seat cross 120.

The food and/or beverage tray may include two tray portions 902, 904, each configured to deploy a tray surface at positions 902a, 904a to meet the other tray portion near the centerline of the seat 101, 601, 701 in front of a person in the seat. The left tray portion 904 is also shown at an intermediate position 904b to illustrate a deployment path.

According to an alternative embodiment, the tray table may include only one portion 902 or 904 configured to deploy from one armrest 122.

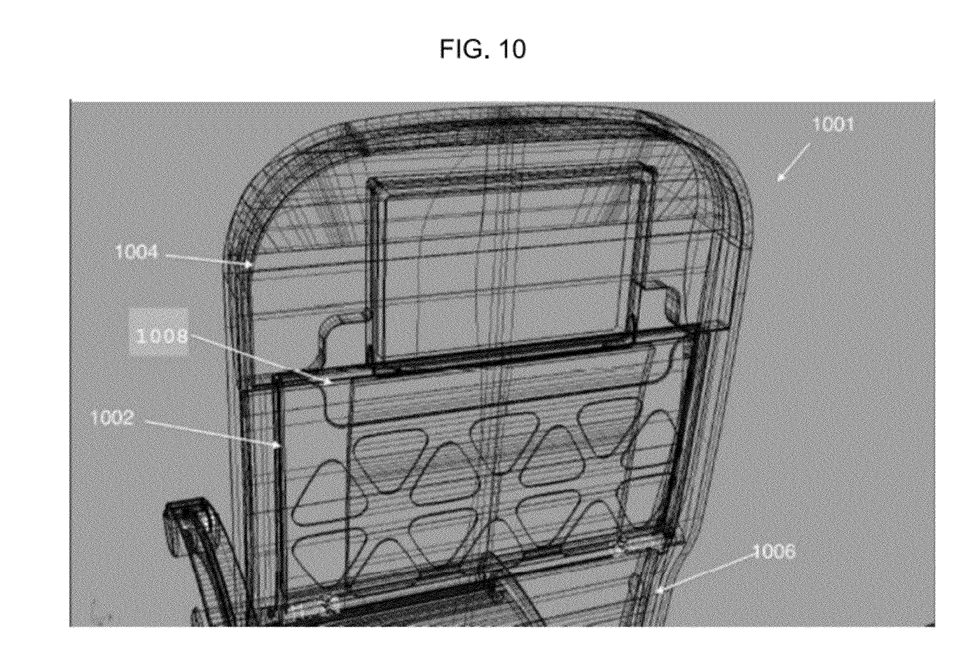

FIG. 10 is a view of an alternative tray table embodiment 1001, wherein the tray table 1002 may be configured to deploy from a seat back 1004. In the embodiment 1001, the tray table 1002 may be normally latched up into a position adjacent to the seat back 1004. When a passenger wishes to use the tray table 1002, the passenger may unlatch the tray table 1002 and swing the tray table down into a substantially horizontal position. The tray table 1002 may be supported by a conventional linkage 1006 that may be coupled to the rear support beam (not shown), the seat cross (not shown), and/or a location on the seat shell.

Optionally, the tray table 1002 may include a literature pocket 1008. The literature pocket may be used to access literature when the tray table 1002 is in a latched, non-deployed position and/or when the tray table 1002 is in a substantially horizontal, deployed position. One advantage of coupling the literature pocket 1008 to the tray table 1002 rather than the seat back 1004 may include increasing knee room for passengers.

Optionally, the tray table 1002 including a literature pocket 1008 may be configured to operate with a conventional, articulated airplane passenger seat (not shown). A conventional airplane passenger seat may include a seat pan, a front support beam operatively coupled to the seat pan, a rear support beam operatively coupled to the seat pan, and two or more seat supports operatively coupled to the front support beam and to the rear seat beam, the two or more seat supports each including legs for mounting to the floor of an airplane fuselage. A seat cross may couple to the front and rear support beams. A seat back may be operatively coupled to the seat pan, the front support beam, the rear support beam, or the seat cross. The seat back may be configured to articulate (recline to variable amounts) relative to the seat pan.

The literature pocket may be formed integrally with the tray table. According to embodiments, the literature pocket may be formed as a cavity adjacent to a bottom side of the tray table, the cavity having an upward facing opening when the tray table is in an upright locked position.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

What is claimed is:

1. An airplane passenger seat, comprising:
a non-articulating seat shell;
a seat support configured to mount to a floor of an airplane fuselage;
a forward and a rear support beam mounted on the seat support, wherein the seat shell, seat support, and the support beams are configured to withstand a 16 G acceleration without detaching from the floor or collapsing; and
a pivot operatively coupled to the seat shell and one of the support beams, and configured to allow rotation of the seat shell relative to the forward or rear support beam.

2. The airplane passenger seat of claim 1, wherein the forward and rear support beams are supported at a distance of less than about 300 millimeters from floor to beam axis.

3. The airplane passenger seat of claim 2, wherein the forward and rear support beams are supported at a distance about equal to or less than 260 millimeters from floor to beam axis.

4. The airplane passenger seat of claim 1, wherein the pivot is operatively coupled to the rear support beam; and
wherein the forward edge of the non-articulating seat shell is configured to rise above the forward support beam when the seat is reclined.

5. The airplane passenger seat of claim 4, further comprising:
at least one spring configured, when a person releases a recline control, to urge the non-articulated seat shell into an upright position.

6. The airplane passenger seat of claim 5, wherein the at least one spring includes a torsion spring acting against the rear support beam.

7. The airplane passenger seat of claim 5, wherein the at least one spring includes a compression spring configured to act on a bell crank to urge the seat shell to rotate forward around the rear support beam.

8. The airplane passenger seat of claim 10, wherein the compression spring includes a gas spring.

9. The airplane passenger seat of claim 4, wherein the non-articulating seat shell is configured to recline up to about 15 degrees from nominal

10. The airplane passenger seat of claim 1, wherein the pivot is operatively coupled to the forward support beam; and
wherein the rear of the non-articulating seat shell is configured to sink below the level of the forward support beam when the seat is reclined.

11. The airplane passenger seat of claim 10, further comprising:
at least one spring configured, when a person releases a recline control, to urge the non-articulated seat shell into an upright position.

12. The airplane passenger seat of claim 11 wherein the at least one spring includes a torsion spring acting against a seat cross to urge the seat shell to rotate forward around the forward support beam

13. The airplane passenger seat of claim 11, wherein the at least one spring includes a compression spring configured to push upward on the rear of the seat shell from the rear support beam or a seat cross.

14. The airplane passenger seat of claim 13, wherein the compression spring includes a gas spring.

15. The airplane passenger seat of claim 10 wherein the non-articulating seat shell is configured to recline up to about 15 degrees from nominal

16. The airplane passenger seat of claim 1, further comprising:
a seat cross configured to mechanically couple the forward support beam to the rear support beam and distribute an acceleration load from the pivot.

17. The airplane passenger seat of claim 16, wherein the seat cross includes an armrest.

18. The airplane passenger seat of claim 16, further comprising:
at least one food or beverage tray configured to pivot from the seat cross.

19. The airplane passenger seat of claim 18, wherein the food or beverage tray includes two tray portions, each configured to deploy a tray surface that meets the other tray portion near the centerline of the seat in front of a person in the seat.

20. The airplane passenger seat of claim 16, further comprising:
a food or beverage tray configured to pivot from the seat cross or the seat shell;
wherein the food or beverage tray includes a literature pocket formed integrally with or coupled to the food or beverage tray.

21. The airplane passenger seat of claim 1, wherein the non-articulated seat shell includes a seat pan disposed in a substantially horizontal plane and an integrally formed backrest support rising in a generally upward and rearward slope from the seat pan; and further comprising:
a leg rest projecting generally downward from a forward edge of the seat pan.

22. The airplane passenger seat of claim 1, further comprising:
a leg rest is formed integrally with and non-articulating with respect to the pennon-articulating seat shell.

23. The airplane passenger seat of claim 1, further comprising:
at least one cushion superjacent the non-articulated seat shell.
